(19) United States
(12) Patent Application Publication
(10) Pub. No.: US 2007/0223492 A1
(43) Pub. Date: Sep. 27, 2007

(54) Methods and apparatus for optimizing a TCP session for a wireless network

(75) Inventors: Albert Lee, Aliso Viejo, CA (US); Fan Zhang, Plano, TX (US); Mahadevan Kulathu Iyer, Thane (IN)

Correspondence Address: Albert Lee, 51 Sprucewood, Aliso Viejo, CA, 92656, US

(73) Assignee: IST International, Inc.

(21) Appl. No.: 11/804,844

(22) Filed: May 21, 2007

(30) Foreign Application Priority Data
Nov. 23, 2005 (US) PCT/US05/42744

(51) Int. Cl. H04L 12/56

(52) U.S. Cl. 370/395.52

(57) ABSTRACT

During a Transmission Control Protocol (TCP) session, a congestion window and slow start threshold may be limited to a range defined by a minimum congestion window and a maximum congestion window based at least in part on the network type of a wireless network. The network type of a wireless network may be determined based in part on one or more round trip times of one or more data segments and one or more TCP session parameters are set to corresponding stored session parameters that are associated with the network type.

### CROSS-REFERENCE TO RELATED APPLICATIONS

This application claims the benefit of U.S. Provisional Patent Application Ser. No. 60/630,895, filed Nov. 24, 2004, the disclosure of which is herein expressly incorporated by reference.

### FIELD OF THE INVENTION

The invention relates, in general, to reliable end-to-end communications and, more particularly, to optimizing a Transmission Control Protocol (TCP) session for a wireless network.

### BACKGROUND OF THE INVENTION

Packet-switched data networks are commonly represented as multi-layer protocol stacks. Examples include the 7 layer Open System Interface (OSI) model and the 4 layer Transmission Control Protocol/Internet Protocol (TCP/IP) model. The ordering of the layers in the OSI model from highest to lowest is: (1) the application layer, (2) the presentation layer, (3) the session layer (4) the transport layer, (5) the network layer, (6) the data-link layer, and (7) the physical layer. The ordering of the layers in the TCP/IP model from highest to lowest is: (1) the application layer, (2) the transport layer (usually TCP), (3) the internet layer (usually IP), and (4) the network access layer. While this is the most common model, not all TCP/IP implementations follow this model. Also, while the TCP/IP model does not follow the OSI model, the TCP/IP transport layer may be mapped to the OSI transport layer and the TCP/IP internet layer may be mapped to the OSI network layer.

The transport layer is responsible for fragmenting the data to be transmitted into appropriately sized segments for transmission over the network. TCP is a transport layer protocol. The transport layer may provide reliability and congestion control processes that may be missing from the network layer. The network layer is responsible for routing data packets over the network. IP is a network layer protocol. The data-link layer manages the interfaces and device drivers required to interface with the physical elements of the network. Examples of the data-link layer include the Ethernet protocol and the Radio Link Protocol (RLP). The physical layer is composed of the physical portions of the network. Examples include serial and parallel cables, Ethernet and Token Ring cabling, antennae, and connectors.

In a TCP/IP network, application programs that need to send data to other computers pass data to the transport layer. At the transport layer, the data is fragmented into appropriately sized segments. These segments are then passed to the network layer where they are packaged into datagrams containing header information necessary to transmit the segments across the network. The network layer then calls upon the lower level protocols (e.g. Ethernet or RLP) to manage the transmission of the data across a particular physical medium. As the datagrams are transmitted from one network to another, they may be fragmented further. At the receiving computer, the process is reversed. The lower level protocols receive the datagrams and pass them to the network layer. The network layer reassembles the datagrams into segments and passes the segments to the transport layer. The transport layer reassembles the segments and passes the data to the application.

IP is limited to providing enough functionality to deliver a datagram from a source to a destination and does not provide a reliable end-to-end connection or flow control. There is no guarantee that a segment passed to a network layer using IP will ever get to its final destination. Segments may be received out of order at the receiver or packets may be dropped due to network or receiver congestion. This unreliability was purposefully built into IP to make it a simple, yet flexible protocol.

TCP uses IP as its basic delivery service. TCP provides the reliability and flow control that is missing from IP. TCP/IP Standard 7 states that “very few assumptions are made as to the reliability of the communication protocols below the TCP layer” and that TCP “assumes it can obtain a simple, potentially unreliable datagram service from the lower level protocols” such as IP. To provide the reliability that is missing from IP, TCP uses the following tools: (1) sequence numbers to monitor the individual bytes of data and reassemble them in order, (2) acknowledgment (ACK) flags to tell if some bytes have been lost in transit, and (3) checksums to validate the contents of the segment (NOTE: IP uses checksums only to validate the contents of the datagram header).

In addition, TCP provides flow control due to the fact that different computers and networks have different capacities, such as processor speed, memory and bandwidth. For example, a web enabled mobile phone will not be able to receive data at the same speed at which a web server may be able to provide it. Therefore, TCP must ensure that the web server provides the data at a rate that is acceptable to the mobile phone. The goal of TCP's flow control system is to prevent data loss due to too high a transfer rate, while at the same time preventing under-utilization of the network resources.

Originally, most TCP flow control mechanisms were focused on the receiving end of the connection, as that was assumed to be the source of any congestion. One example of a receiver-based flow control mechanism is receive window (RWND) sizing. The size of RWND is advertised by a receiver in the ACKs that it transmits to the sender. The size of RWND is based on factors such as the size of the receiver's receive buffers and the frequency at which they are drained.

However, flow control mechanisms based on the receiver do not address problems that may occur with the network. Such problems may be network outages, high traffic loads and overflowing buffers on network routers. A receiver may be operating smoothly, but the network may be dropping packets because the sender is transmitting data at too high a rate for the network to handle. Therefore, sender-based flow control methods were developed. RFC 2581 details TCP's four flow control methods: (1) slow start, (2) congestion avoidance, (3) fast retransmit, and (4) fast recovery.

The four flow control methods are used to recover from, or to prevent, congestion related problems. Which method is used depends on which congestion related problem is encountered or to be prevented Slow start is used at the start of a connection to probe the network capacity or after a retransmission timer indicates that a segment has been lost. When a segment is transmitted or an ACK is received, the TCP sender predicts the round trip time of the next segment and calculates the retransmission timeout. When the next segment is transmitted, the retransmission timer for that segment is started with the new value of the retransmission timeout. If the retransmission timer expires before the ACK for that segment is received, then the segment is presumed lost. Congestion avoidance is used after slow-start reaches a predetermined threshold or after potential congestion is detected by the receipt of a duplicate ACK. Fast retransmit is used to retransmit a potentially lost packet before the retransmission timer indicates that it is lost. Fast recovery is used to prevent unnecessary retransmission of data.

Despite the improvements afforded by the aforementioned flow control methods, the emphasis has been on reliability of the TCP connections at the expense of network performance. Thus, there is a need in the art to optimize TCP connectivity such that neither reliability nor performance are compromised.

### BRIEF SUMMARY OF THE INVENTION

Methods and apparatus for optimizing a Transmission Control Protocol (TCP) session for a wireless network is disclosed. In one embodiment, a method includes limiting a congestion window and a slow start threshold to a range defined by a minimum congestion window and a maximum congestion window, wherein the minimum congestion window and the maximum congestion window are based at least in part on a network type of the wireless network.

Other aspects, features, and techniques of the invention will be apparent to one skilled in the relevant art in view of the following detailed description of the invention.

### BRIEF DESCRIPTION OF THE DRAWINGS

FIG. 1 depicts a simplified system diagram of a system wherein one or more aspects of the invention may be performed, according to one or more embodiments;

FIG. 2 is a flow diagram of how a TCP module may limit a congestion window, according to one or more embodiments;

FIG. 3 is a flow diagram of how a TCP module may limit a slow start threshold, according to one or more embodiments;

FIG. 4 is a flow diagram of how a TCP module may limit a retransmission timeout, according to one or more embodiments;

FIG. 5 is a flow diagram of a how a TCP module may increase a congestion window during a TCP congestion avoidance phase, according to one or more embodiments;

FIG. 6 is a flow diagram of a modified TCP fast retransmit/fast recovery process, according to one or more embodiments;

FIG. 7 is a flow diagram of a modified TCP retransmission upon timeout process, according to one or more embodiments; and

FIG. 8 is a flow diagram of how a TCP module may determine a network type and set one or more TCP session parameters, according to one or more embodiments.

### DETAILED DESCRIPTION OF EXEMPLARY EMBODIMENTS

A method and apparatus for optimizing a Transmission Control Protocol (TCP) session for a network node in communication with a wireless network are disclosed. One aspect of the invention is to modify the operation of the TCP session to conform to one or more TCP session parameters associated with a network type of a wireless network. Another aspect of the invention is to provide a flexible method for determining the network type of the wireless network and set one or more TCP session parameters to one or more corresponding stored session parameters associated with the network type.

In one embodiment, a congestion window and a slow start threshold may be limited to a range defined by a minimum congestion window and a maximum congestion window based at least in part on a network type of the wireless network. In another embodiment, one or more TCP session parameters may be set to one or more corresponding stored session parameters based on a network type. A retransmission timeout may also be set to a value less than or equal to a maximum retransmission timeout based at least in part on the network type. In another embodiment, a congestion window may be increased during a TCP congestion avoidance phase by a congestion window increase speed, based at least in part on the network type.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. The terms “network node”, “sender”, and “receiver” are understood to include any electronic device that contains a processor, such as a central processing unit.

When implemented in software, the elements of the invention are essentially the code segments to perform the necessary tasks. The code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

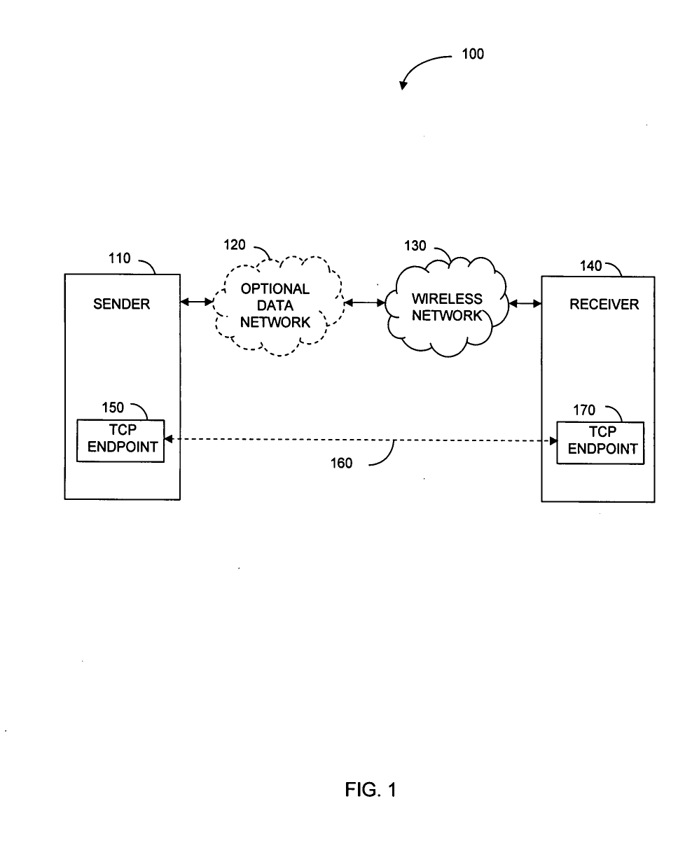

FIG. 1 depicts an exemplary system 100 in which one or more aspects of the invention may be implemented. The system 100 consists of a sender 110 in communication with a receiver 140 over an optional data network 120 and a wireless network 130. While in the embodiment shown in FIG. 1 optional data network 120 is present, in another embodiment it may be omitted.

Sender 110 may be a network node adapted to create a TCP virtual circuit 160 with another device through the use of a TCP module resident on sender 110. For example, a sender 110 may be a desktop computer, a laptop computer, a cellular telephone, a Personal Digital Assistant (PDA), a server, a network adapter, or an embedded computer. It should be appreciated that the above list is exemplary only, as any device capable of creating a TCP virtual circuit 160 with another device may be considered a sender 110. A TCP module may be part of a Transmission Control Protocol/Internet Protocol (TCP/IP) stack shared by more than one program on sender 110 or it may exist as part of another program. In addition, it should be appreciated that a sender 110 that contains a TCP module consistent with the principles of the invention may further contain other TCP modules that are not so configured.

Receiver 140 may be a network node adapted to create a TCP virtual circuit 160 with another device through the use of a TCP module resident on receiver 140. For example, a receiver 140 may be a desktop computer, a laptop computer, a cellular telephone, a Personal Digital Assistant (PDA), a server, a network adapter, or an embedded computer. It should be appreciated that the above list is exemplary only as any device capable of creating a TCP virtual circuit 160 with another device may be considered a receiver 140. A TCP module may be part of a TCP/IP protocol stack shared by more than one software program on receiver 140 or it may exist as part of another software program. In addition, it should be appreciated that a receiver 140 that contains a TCP module consistent with the principles of the invention may further contain other TCP modules that are not configured as such.

While units 110 and 140 in FIG. 1 have been described as “sender” and “receiver” respectively, it should be appreciated that these terms are arbitrary and that sender 110 may at times be transmitting data to receiver 140, while at other times, receiver 140 may be transmitting data to sender 110.

In the embodiment of FIG. 1, a TCP virtual circuit 160 exists between sender TCP endpoint 150 and receiver TCP endpoint 170. While the details of a TCP virtual circuit are beyond the scope of this disclosure, such a circuit is depicted in FIG. 1 to illustrate that reliable TCP sessions, with their attendant flow control algorithms, may be created in sender 110 and receiver 140, even if the underlying network protocols and networks are unreliable. It should be understood that more than one TCP virtual circuit 160 between sender 110 and receiver 140 may exist simultaneously.

Optional data network 120 may consist of a single network or multiple interconnected networks. Examples of networks that may make up optional data network 120 include the Internet, local area networks, wide area networks, digital subscriber line (DSL) networks, cable networks, dial-up networks, cellular data networks, and satellite networks. They may be packet-switched networks or circuit-switched networks. The above list of networks that may make up optional data network 120 is exemplary only and it should be appreciated that any network that may be connected to another network through the use of one or more network layer protocols, such as the Internet Protocol (IP), may be used.

Wireless network 130 may consist of a single network with at least one wireless physical link, or multiple interconnected networks wherein at least one network contains at least one wireless physical link. Wireless network 130 may be a cellular data network, such as a Code Division Multiple Access 2000 1x (CDMA2000 1x) network, a CDMA 2000 1x Evolution Data Only (CDMA2000 1xEVDO) network, a General Packet Radio Services (GPRS) network, a Universal Mobile Telecommunications System (UMTS) network, a Universal Terrestrial Radio Access Network (UTRAN) network, and an Enhanced Data for GSM Evolution (EDGE) network. The above list of networks that may make up wireless network 130 is exemplary only and it should be appreciated that any wireless network that may be connected to another network through the use of one or more network layer protocols, such as IP, may be used.

One or more TCP modules in a sender 110 and/or a receiver 140 may be adapted to optimize a TCP session. In one embodiment, adaptations may include a limitation on the size of the congestion window (CWND) and the slow start threshold (SSTHRESH) through the introduction of two new TCP session parameters, minimum CWND (min_CWND) and maximum CWND (max_CWND). Another adaptation may be a limitation on the size of a TCP retransmission timeout (RTO), through the introduction of another TCP session parameter, maximum RTO (max_RTO). Other adaptations may include other TCP session parameters such as a CWND increase speed (speed_UP), a CWND decrease speed (speed_DOWN), and an RTO multiplier (RTO_MULT).

In certain embodiments, a TCP module may contain further adaptations based at least in part on the network type, including a modified TCP fast recovery process and a modified TCP retransmission upon timeout process.

One or more of the TCP session parameters and TCP processes may be based at least in part on the network type of wireless network 130. In one embodiment, one or more of the TCP session parameters may be pre-determined based at least in part on one or more characteristics of a network type and then programmed into a sender 110 and/or a receiver 140. In certain embodiments, multiple sets of pre-determined session parameters, each associated with a network type, may be pre-stored in a sender 110 and/or a receiver 140. In these embodiments, a TCP module may be adapted to determine the network type of wireless network 130 during a TCP session and update one or more TCP session parameters with corresponding session parameters contained in a pre-stored set of session parameters associated with the network type.

In certain embodiments, network types may be identified as “high bandwidth” and “low bandwidth.” It should be understood that the terms “high bandwidth” and “low bandwidth” are relative and one network type may be considered “high bandwidth” compared to another network type, but considered “low bandwidth” to yet another. For example, in one embodiment, a CDMA2000 1x network may be considered a “low bandwidth” network type and a CDMA2000 1x EVDO network may be considered a “high bandwidth” network type because a CDMA2000 1x EVDO network generally has a higher bandwidth, lower propagation delay, and lower queuing delays than a CDMA2000 1x network. While CDMA2000 1× and CDMA2000 1x EVDO networks have been used to illustrate the concept of network types, it should be appreciated that other wireless networks are equally applicable.

In an alternative embodiment, there may be several network types, such as “highest bandwidth”, “high bandwidth”, “medium bandwidth”, “low bandwidth” and “lowest bandwidth.”

In one embodiment, the network type may refer to the current network characteristics of wireless network 130. In these situations the network type of wireless network 130 may change before, during, or after a TCP session, while the physical network remains the same. For example, the network type may change due to changes in the bandwidth, propagation delay, packet loss, queuing delays, etc., of wireless network 130. The changes may occur due to conditions such as poor air quality, frequent handoffs of the receiver 140 from one base transceiver station (BTS) to another, or the distance between receiver 140 and a BTS. For example, when a receiver 140 is close to a BTS, the network type of wireless network 130 may be considered “high bandwidth.” However, as a receiver 140 moves further from the BTS, the network type may change to “low bandwidth” since queuing delays and packet loss may increase due to the increased distance between receiver 140 and the BTS. In addition to environmental factors, changing traffic loads over wireless network 130 may result in changes to the network type.

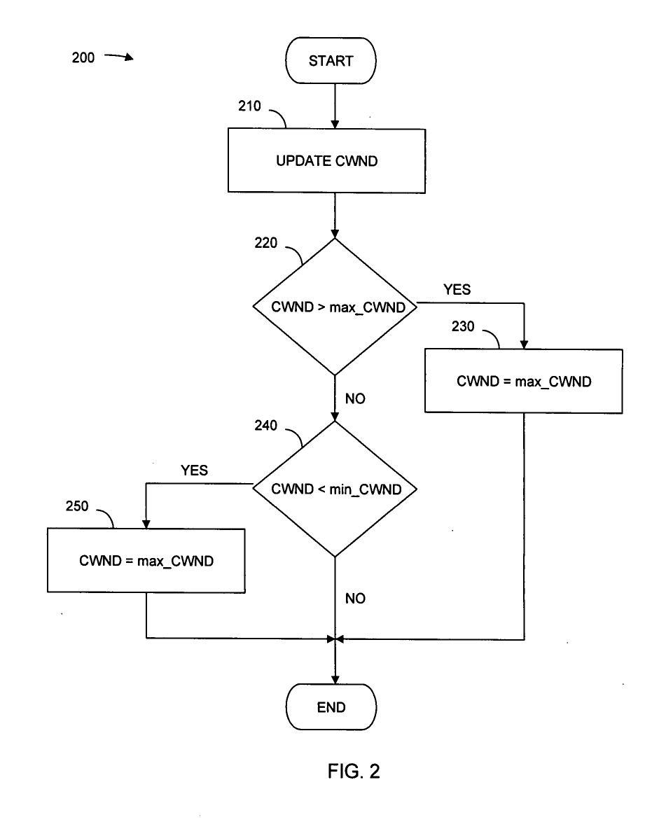

FIG. 2 displays one embodiment of how min_CWND and max_CWND may be used to limit CWND during a TCP session in a network node which may be a sender (e.g. sender 110) or a receiver (e.g. receiver 140). Process 200 begins upon the update of CWND, as shown in block 210. CWND may be updated via several methods during a TCP session. For example, in the slow start phase outlined in RFC 2583, CWND is increased by 1 for each non-duplicate acknowledgment (NDACK) received. In the congestion avoidance phase outlined in RFC 2583, CWND is increased by 1 for every CWND number of segments acknowledged by one or more NDACKs. These examples should not be read as a limitation on the invention, as it is applicable to any update of CWND.

Process 200 proceeds to block 220 where CWND is compared to max_CWND. If CWND is greater than max_CWND, then process 200 proceeds to block 230 where CWND is set to max_CWND. If, however, CWND is less than max_CWND, then process 200 proceeds to block 240.

At block 240, CWND is compared to min_CWND. If CWND is less than min_CWND, then process 200 proceeds to block 250 where CWND is set to min_CWND. If, however, CWND is greater than min_CWND, then it remains unchanged.

An example of where CWND may be limited is the update of CWND that occurs after a TCP retransmission timer expires and indicates that a packet has been lost (i.e. a timeout). In some TCP implementations, CWND is reduced to a small value after a timeout, usually between 1 and 4. However, instead of CWND being reduced to a value between 1 and 4, it may be reduced to the value of min_CWND.

Another example of where CWND may be limited is the update of CWND in the congestion avoidance phase. In some TCP implementations, CWND is updated by 1 for every CWND number of segments (or bytes if CWND is not expressed in segments) acknowledged. If CWND exceeds max_CWND in the congestion avoidance phase, then it may be set to max_CWND.

The order of one or more of the acts depicted in process 200 may be changed while still conforming to the principles of the invention. For example, in certain embodiments, CWND may be compared to min_CWND before being compared to max_CWND. Depending on the TCP process used to update CWND, it may be necessary to only compare CWND to max_CWND and not min_CWND (e.g. when CWND is increased), and vice-versa (e.g. when CWND is decreased). In addition, CWND may be limited by the size of the receive window (RWND) of a receiver.

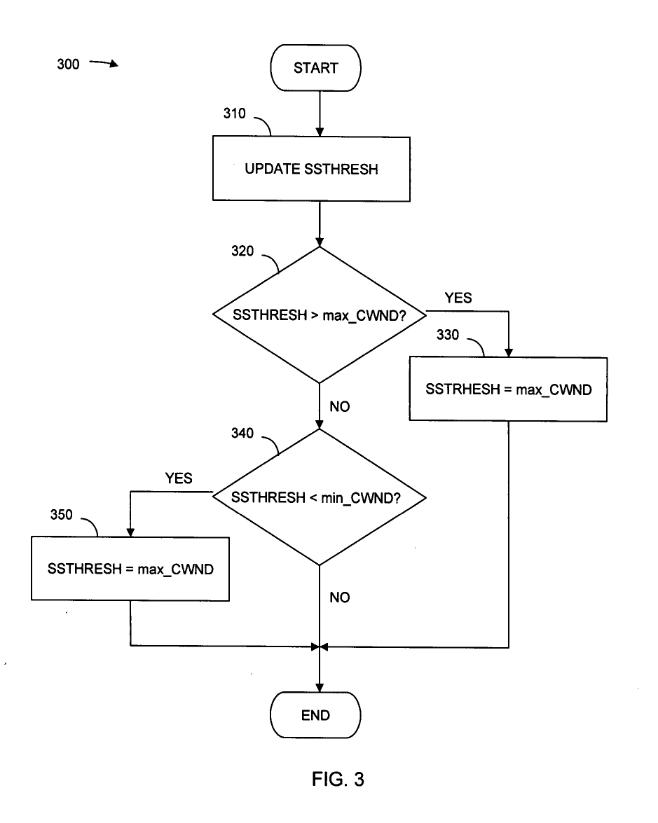

FIG. 3 displays one embodiment of how min_CWND and max_CWND may be used to limit SSTHRESH during a TCP session in a network node. Process 300 begins upon the update of SSTHRESH, as shown in block 310. SSTHRESH may be updated via several methods during a TCP session. For example, at startup, some TCP implementations set SSTHRESH to the size of the RWND. In another example, SSTHRESH may be reduced to a percentage of CWND in the TCP fast recovery phase. These examples should not be read as a limitation on the invention, as it is applicable to any update of SSTHRESH.

Process 300 proceeds to block 320 where SSTHRESH is compared to max_CWND. If SSTHRESH is greater than max_CWND, then process 300 proceeds to block 330 where SSTHRESH is set to max_CWND. If, however, SSTHRESH is less than max_CWND, then process 300 proceeds to block 340.

At block 340, SSTHRESH is compared to min_CWND. If SSTHRESH is less than min_CWND, then process 300 proceeds to block 350 where SSTHRESH is set to min_CWND. If, however, SSTHRESH is greater than min_CWND then it remains unchanged.

An example of where SSTHRESH may be limited is the update of SSTHRESH that occurs after a timeout. In some TCP implementations, SSTHRESH is reduced to one half the value of CWND after a timeout. However, if as the result of this reduction, SSTHRESH is less than min_CWND, then SSTHRESH may be set to min_CWND.

Another example of where SSTHRESH may be limited is at the start of the TCP session. In some TCP implementations, SSTHRESH is set to an arbitrary high value or to RWND. If, however, this arbitrary high value or RWND is higher than max_CWND, then SSTHRESH may be set to max_CWND.

As with FIG. 2, the order of one or more of the acts depicted in process 300 may be changed while still conforming to the principles of the invention. For example, in certain embodiments, SSTHRESH may be compared to min_CWND before being compared to max_CWND. Depending on the TCP process used to update SSTHRESH, it may be necessary to only compare SSTHRESH to max_CWND and not min_CWND (e.g. when SSTHRESH is increased), and vice-versa (e.g. when SSTHRESH is decreased). In addition, SSTHRESH may be limited by RWND.

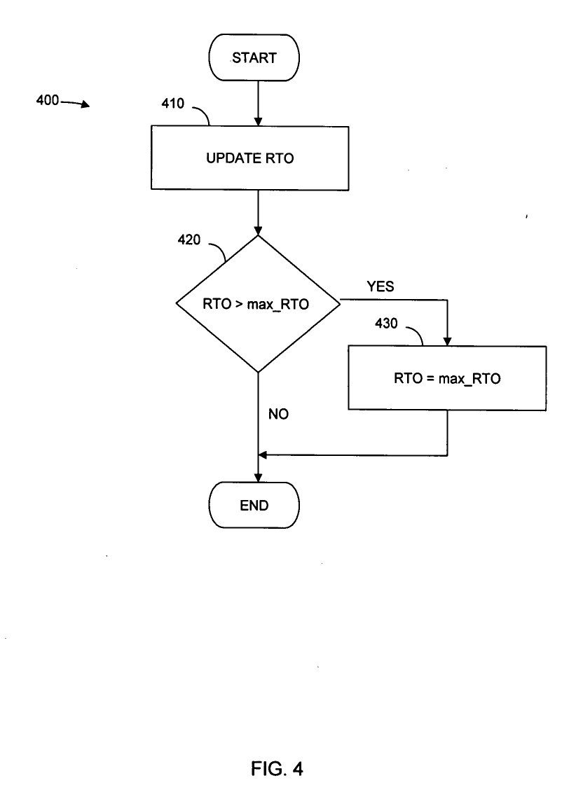

FIG. 4 displays one embodiment of a method of how RTO may be limited to a value less than or equal to max_RTO during a TCP session in a network node. Process 400 begins at block 410 when the RTO for the next segment to be transmitted (or retransmitted) is determined. RTO may be determined via several methods in a TCP session. For example, RTO may be determined by one method upon the receipt of an NDACK and by another method when a retransmission timer expires.

Process 400 proceeds to block 420 where RTO is compared to max_RTO. If RTO is greater than max_RTO, then process 400 proceeds to block 430 where RTO is set to max_RTO. If, however, RTO is less than max_RTO, it remains unchanged.

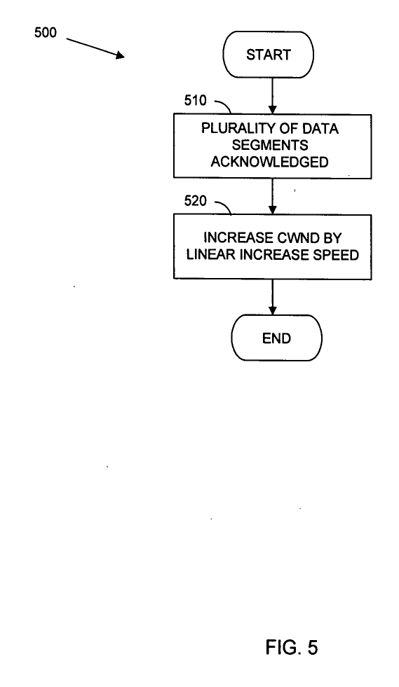

FIG. 5 depicts one embodiment of how SPEED_UP may be used to increase CWND during the congestion avoidance phase. The congestion avoidance phase is used in a TCP session after CWND reaches the value of SSTHRESH in the slow start phase, or after congestion is detected by the receipt of a series of duplicate acknowledgments (DACKs). In certain TCP implementations, CWND is updated by 1 during the congestion avoidance phase for every CWND number of segments acknowledged by a receiver (in the form of NDACKs). It should be noted that some TCP implementations do not express CWND as a number of segments, but as a number of bytes. This process is applicable to those implementations as well, however for the sake of simplicity CWND has been expressed here as a number of segments.

Process 500 begins when a plurality of data segments have been acknowledged in block 510. Process 500 proceeds to block 520 where CWND is increased by SPEED_UP. This differs from the usual implementations of TCP in that SPEED_UP is not limited to 1 and the plurality of data segments acknowledged in block 510 is not limited to CWND number of segments. In one embodiment, SPEED_UP may be adjustable, while in another embodiment, it may be fixed. It should be appreciated that CWND is still limited to no more than max_CWND.

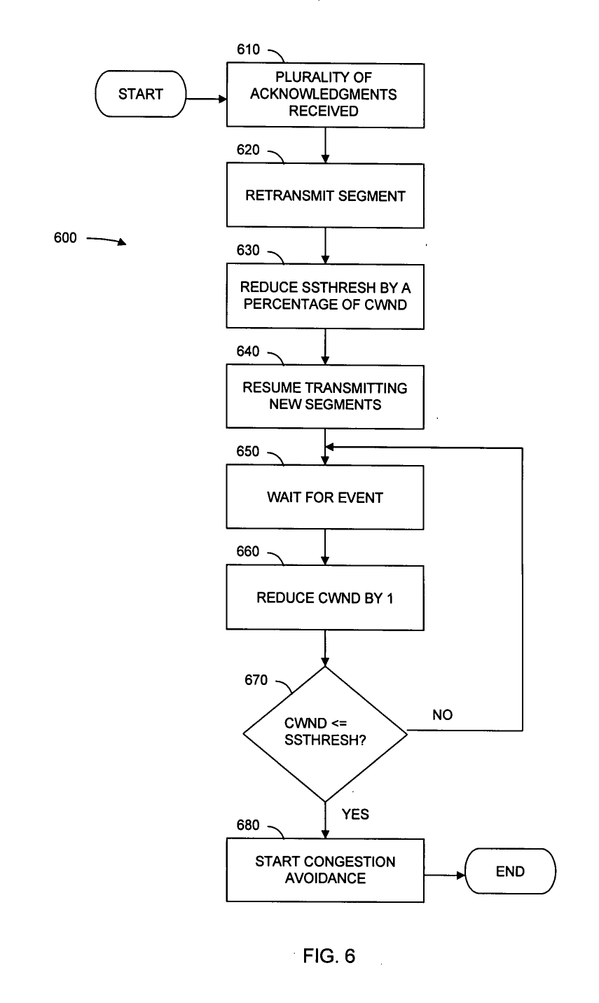

FIG. 6 displays one embodiment of a modified TCP fast retransmit/fast recovery process in accordance with the principles of the invention. In standard TCP, upon the receipt of 3 consecutive DACKS, TCP will presume that the segment associated with the DACKs was lost and enter the fast retransmit phase where the segment associated with DACKs is retransmitted. “Fast retransmit” refers to the retransmission of a segment before a timeout indicates that the segment is lost. After the fast retransmit, TCP will enter the fast recovery phase where SSTHRESH and CWND are reduced to a percentage of CWND. In some TCP implementations CWND is reduced to one half CWND plus 3 to reflect the 3 segments that were received at the client and triggered the DACKs.

After SSTHRESH and CWND are reduced, CWND may be temporarily inflated to allow unacknowledged segments to be retransmitted until the lost segment is acknowledged, as per the RFC for TCP Reno. Linux TCP avoids this artificial inflation by doing a gradual 50 percent reduction of CWND after the fast retransmit. Linux TCP performs this gradual reduction by decreasing CWND by 1 for every two maximum segment size (MSS) amount of bytes acknowledged in new NDACKs arriving after the fast retransmit.

Process 600 starts at block 610 when a plurality of DACKs corresponding to a data segment are received by the network node before a retransmission timer expires. While in one embodiment, 3 DACKs may be required to enter the fast retransmit phase, in other embodiments any plurality of DACKs may be sufficient.

Process 600 moves to block 620 where the segment corresponding to the DACKs is retransmitted. This is a standard TCP fast retransmit procedure. At block 630, process 600 diverges from standard TCP when SSTHRESH is reduced to a percentage of CWND. Unlike other TCP implementations, the percentage used in block 630 may be based at least in part on the network type of the wireless network. In one embodiment, the percentage may be adjustable. For example, in one embodiment the percentage used in block 630 may be adjustable by the user of the network node. In another embodiment, it may be updated by the operator of the wireless network or a software vendor. It should be appreciated that SSTHRESH is still limited by min_CWND and max_CWND.

After SSTHRESH is reduced, process 600 proceeds to block 640 where the TCP session resumes transmitting new segments. At block 650, process 600 waits for an event before proceeding to block 660 where CWND is reduced by 1. In one embodiment, this event may be the passage of time, expressed in clock cycles, units of time, or any other suitable timing parameter. In another embodiment, the event may be the receipt of one or more NDACKs. For example, the event may be the receipt of one or more NDACKs acknowledging at least (100/(100−X))*MSS new amount of bytes since the previous such event, where X is the magnitude of the percentage used in block 630 (e.g. if SSTHRESH was reduced to 75% of CWND in block 630, then X is equal to 75 in block 660). It should be appreciated that the previous example is for illustrative purposes only and should not be considered a limitation on the invention. It should be further appreciated that the TCP module may still be transmitting new data segments in the background while waiting for the event to occur.

If the event described above occurs, process 600 may proceed to block 660 where CWND is reduced. In one embodiment, the reduction of CWND in block 660 may be 1, however, in other embodiments, the reduction may be another value. This value may be based at least in part on the network type of the wireless network.

Process 600 then proceeds to block 670 where CWND is compared to SSTHRESH. If CWND is less than, or in some embodiments equal to, SSTHRESH, then the process 600 proceeds to block 680 where TCP enters the congestion avoidance phase. Otherwise, process 600 loops back to block 650 to wait for another event.

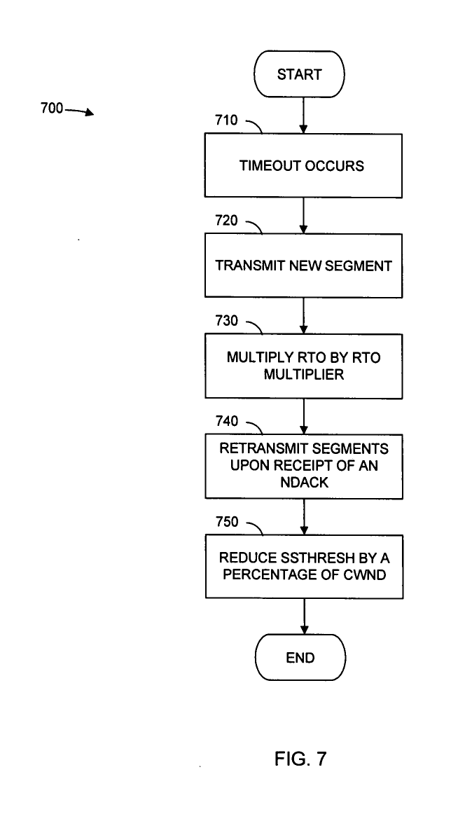

FIG. 7 display one embodiment of a modified TCP recovery upon timeout process in accordance with the principles of the invention. In standard TCP, when a timeout occurs, TCP starts the recovery upon timeout process. In this process the lost segment associated with the expired retransmission timer is retransmitted, SSTHRESH is reduced to a percentage of CWND (usually 50% for standard TCP), CWND is reduced to a value between 1 and 4, and TCP restarts incrementing CWND using the slow start process. In addition, the RTO for the lost segment is multiplied by 2, according to an algorithm known as Karn's algorithm.

The modified retransmission upon timeout process 700 starts at block 710 when a timeout occurs and indicates that a segment is lost. Process 700 proceeds to block 720 where a new segment is transmitted. This is a divergence from standard TCP which dictates that the lost segment is transmitted, not a new segment. However, due to the fact that the network node is in communication with a wireless network, it is possible that the segment is not lost and that the retransmission timer expired due to retransmissions between a base station controller and the receiver. Therefore, it may be proper to transmit a new segment. While in one embodiment only a new segment is transmitted, it should be appreciated that in other embodiments a new segment and the lost segment may also be retransmitted. The determination of whether to transmit the new segment may be based at least in part on the network type of the wireless network.

At block 730, RTO is multiplied by RTO_MULT as opposed to the standard 2 specified in Karn's algorithm. In one embodiment, RTO_MULT may be set to 1.5. In another embodiment, RTO_MULT may be set to another value. It should be noted that RTO is still limited by max_RTO.

At block 740, one or more unacknowledged segments are retransmitted whereas standard TCP specifies that the entire remaining window of unacknowledged segments should be retransmitted. In one embodiment, only the first 2 of the remaining window of unacknowledged segments may be transmitted.

At block 750, SSTHRESH is reduced to a percentage of CWND instead of the standard TCP 50% reduction. The percentage may be adjustable by the user of the network node or the operator of a wireless network or a software vendor. It should be appreciated that SSTHRESH is still limited by min_CWND.

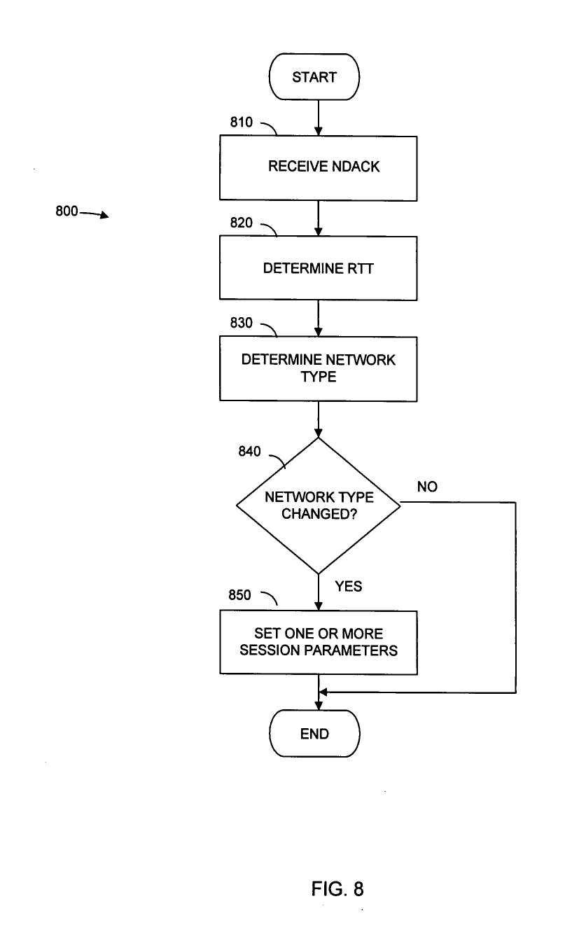

FIG. 8 depicts one embodiment of how a TCP module in a network node may determine the network type of a wireless network during a TCP session and set one or more session parameters to one or more corresponding stored session parameters associated with the network type. The TCP session parameters may include one or more of min_CWND, max_CWND, max_RTO, SPEED_UP, SPEED_DOWN, and RTO_MULT. In addition, one or more modifications to the fast retransmit/fast recovery and retransmission upon timeout processes may be set.

Process 800 begins at block 810 when an NDACK is received by a TCP module in a sender in response to a segment that was previously transmitted. It should be appreciated that an NDACK received by the sender in block 1 may also be a delayed ACK as the term is known in the art.

Process 800 proceeds to block 820 where the round trip time (RTT) of at least one of the data segments associated with the received NDACK is determined. The RTT of a segment may be the elapsed time between the transmission of a segment from a sender and the receipt of its corresponding NDACK, however, any consistent method to determine the RTT of a segment may be used. It may be expressed in units of time, clock cycles or any other suitable timing parameter.

After determining the RTT, process 800 proceeds to block 830 where the network type of the wireless network is determined. In one embodiment, this determination may be made by comparing the RTT determined in block 820 to one or more threshold RTTs. This comparison may be performed every time an RTT is determined, or it may be performed every time a predetermined number of RTTs have been determined.

If an RTT falls within a region defined by one or more threshold RTTs, then the network type may be determined to be the network type associated with that region. In one embodiment, there may be two available network types, “high bandwidth” and “low bandwidth” corresponding to two regions defined by one or more threshold RTTs. If an RTT falls within the “low bandwidth” region, the network type may be considered low bandwidth. If the network type falls within the “high bandwidth” region, the network type may be considered high bandwidth. It should be appreciated that in other embodiments, there may be more than two network types.

In certain embodiments, to prevent a spurious large or small RTT from determining the perceived network type, a predetermined number of consecutive RTTs that exceed an RTT threshold may be used to determine the network type. For example, a predetermined number of RTTs that exceed an RTT threshold since the last change in the network type may be required. In yet another embodiment, an average of calculated RTTs may be used. This average may consist of the average of the RTTs determined since the start of the TCP session, the average of a predetermined number of RTTs, the average of the RTTs determined since a previous determination of the network type, or the average of the RTTs determined since the last change in the network type.

Referring still to FIG. 8, process 800 moves to block 840 where a determination of whether the network type has changed is made (i.e. whether the network type determined in block 830 is different than the last determined network type, if any). If the network type has changed, process 800 proceeds to block 850 where one or more of the TCP session parameters may be set. Otherwise the process ends. It should be appreciated that in certain embodiments, block 840 may be omitted and process 800 may set one or more TCP session parameters after every determination of the network type.

At block 850, one or more TCP session parameters are set to one or more corresponding stored session parameters associated with the network type. In certain embodiments, there may be more than one set of stored session parameters, wherein each set is associated with a different network type.

In one embodiment, one or more stored session parameters may be adjustable by the user of a network node that contains a TCP module consistent with the principles of the invention. In another embodiment, one or more stored session parameters may be adjustable by another party. For example, one or more stored session parameters on a mobile phone may be adjustable over the cellular network by the operator of the cellular network or a software vendor. It should be appreciated that one or more of the modifications to the modified TCP fast retransmit/fast recovery and modified TCP recovery upon timeout processes may be similarly adjustable.

It should also be appreciated that in certain embodiments, an initial network type may be stored in the network node. At the start of the TCP session, this initial network type may be used to set one or more TCP session parameters before any segments have been transmitted. For example, if the stored initial network type is “low bandwidth”, one or more TCP session parameters may be set to one or more corresponding stored session parameters associated with the “low bandwidth” network type.

In one embodiment, if the network type changes during the TCP session, it may be necessary to increase or decrease CWND to bring it within the new values of min_CWND and max_CWND. For example, if max_CWND changes due to a network type change and CWND is above max_CWND then CWND must be reduced to bring it within the limit imposed by max_CWND. In one embodiment, CWND may be reduced immediately after the network type change. In another embodiment, CWND may be reduced by SPEED_DOWN number of segments upon each occurrence of an event after the network type change until CWND is less than or equal to max_CWND. This gradual reduction may be based on events such as the passage of time or the receipt of one or more NDACKs.

Similarly, if CWND is less than min_CWND due to a network change, then CWND may be increased immediately after the network type change or gradually, based on events such as the passage of time or the receipt of one or more NDACKs.

While the processes of FIG. 2-8 have been described in the above embodiments, it should be appreciated that these are for exemplary value only and other embodiments are applicable to the current invention. The order of one or more of the acts depicted in the processes of FIG. 2-8 may be changed while still conforming to the principles of the invention. For the sake of simplicity, the processes of FIG. 2-8 have been defined in general steps and it should be appreciated that other steps consistent with the principles of the invention may be included.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for optimizing a Transmission Control Protocol (TCP) session for a network node in communication with a wireless network comprising the act of limiting a congestion window and a slow start threshold to a range defined by a minimum congestion window and a maximum congestion window, wherein the minimum congestion window and the maximum congestion window are based at least in part on a network type of the wireless network.

2. The method of claim 1, further comprising the act of limiting a retransmission timeout to less than or equal to a maximum retransmission timeout, wherein said maximum retransmission timeout is based at least in part on the network type of the wireless network.

3. The method of claim 1, further comprising the act of increasing the congestion window by a congestion window increase speed upon a receipt of a plurality of non-duplicate acknowledgments during a TCP congestion avoidance phase, wherein said congestion window increase speed is based at least in part on the network type of the wireless network.

4. The method of claim 1, further comprising, upon a start of a TCP fast recovery phase, the acts of:
reducing the slow start threshold to a percentage of the congestion window; and
reducing the congestion window by a value based at least in part on said percentage once upon each occurrence of an event until the congestion window is less than or equal to the slow start threshold, wherein said event is one of a receipt of one or more non-duplicate acknowledgments or a passage of time.

5. The method of claim 1, further comprising the act of reducing the congestion window by a congestion window decrease speed once upon each occurrence of an event until the congestion window is less than or equal to the maximum congestion window, wherein said event is one of a receipt of one or more non-duplicate acknowledgments or a passage of time.

6. The method of claim 1, further comprising, upon the expiration of a retransmission timer, the acts of:
transmitting a new data segment, wherein said new data segment has not been previously transmitted;
multiplying a retransmission timeout by a retransmission timeout multiplier;
reducing the slow start threshold to a percentage of the congestion window; and
retransmitting one or more previously transmitted data segments upon a receipt of a non-duplicate acknowledgment, wherein said one or more previously transmitted data segments are not associated with one or more previously received non-duplicate acknowledgments.

7. A method for optimizing a Transmission Control Protocol (TCP) session for a network node in communication with a wireless network comprising the acts of:
determining a network type of the wireless network based at least in part on one or more round trip times and one or more round trip time thresholds, wherein said one or more round trip times are associated with one or more data segments transmitted during said TCP session and said one or more round trip time thresholds are associated with one or more network types; and
setting a plurality of TCP session parameters to a plurality of corresponding stored session parameters associated with the network type.

8. The method of claim 7, wherein determining the network type comprises the act of determining whether said one or more round trip times, or a value derived from said one or more round trip times, are within a range defined at least in part by one or more of said one or more round trip time thresholds.

9. The method of claim 8, wherein the network type is a low bandwidth network type if said one or more round trip times, or the value derived from said one or more round trip times, are greater than a low bandwidth round trip time threshold.

10. The method of claim 8, wherein the network type is a high bandwidth network type if said one or more round trip times or the value derived from said one or more round trip times, are less than a high bandwidth round trip time threshold.

11. The method of claim 7, wherein one or more of said plurality of corresponding stored session parameters are adjustable.

12. The method of claim 7, wherein said plurality of TCP session parameters include one or more of a minimum congestion window, a maximum congestion window, a maximum retransmission timeout, a congestion window increase speed, a congestion window decrease speed and a retransmission timeout multiplier.

13. The method of claim 12, further comprising the act of limiting a congestion window to a range defined by the minimum congestion window and the maximum congestion window.

14. The method of claim 12, further comprising the act of limiting a slow start threshold to a range defined by the minimum congestion window and the maximum congestion window.

15. The method of claim 12, further comprising the act of increasing a congestion window by the congestion window increase speed upon a receipt of a plurality of non-duplicate acknowledgments during a TCP congestion avoidance phase.

16. The method of claim 12, further comprising the act of limiting a retransmission timeout for the TCP session to less than or equal to the maximum retransmission timeout.

17. The method of claim 12, further comprising reducing a congestion window by the congestion window decrease speed once upon each occurrence of an event until the congestion window is less than or equal to the maximum congestion window, wherein said event is one of a receipt of one or more non-duplicate acknowledgments or a passage of time.

18. A network node comprising:
a network interface adapted to provide connectivity to a data network;
a processor coupled to said network interface; and
a memory coupled to said processor, said memory containing processor executable instruction sequences to cause the processor to:
limit a congestion window and a slow start threshold to a range defined by a minimum congestion window and a maximum congestion window, wherein the minimum congestion window and the maximum congestion window are based at least in part on a network type of the wireless network.

19. The network node of claim 18, wherein said memory further includes processor executable instruction sequences to cause the processor to limit a retransmission timeout to less than or equal to a maximum retransmission timeout, wherein said maximum retransmission timeout is based at least in part on the network type of the wireless network.

20. The network node of claim 18, wherein said memory further includes processor executable instruction sequences to cause the processor to increase the congestion window by a congestion window increase speed upon a receipt of a plurality of non-duplicate acknowledgments during a TCP congestion avoidance phase, wherein said linear increase speed is based at least in part on the network type of the wireless network.

21. The network node of claim 18, wherein said memory further includes processor executable instruction sequences to cause, upon a start of a TCP fast recovery phase, the processor to:
reduce the slow start threshold to a percentage of the congestion window upon a start of a TCP fast recovery phase; and
reduce the congestion window by a value based at least in part on said percentage once upon each occurrence of an event until the congestion window is less than or equal to the slow start threshold, wherein said event is one of a receipt of one or more non-duplicate acknowledgments or a passage of time.

22. The network node of claim 18, wherein said memory further includes processor executable instruction sequences to cause the processor to reduce the congestion window by a congestion window decrease speed once upon each occurrence of an event until the congestion window is less than or equal to the maximum congestion window, wherein said event is one of a receipt of one or more non-duplicate acknowledgments or a passage of time.

23. The network node of claim 18, wherein said memory further includes processor executable instruction sequences to cause, upon the expiration of a retransmission timer, the processor to:
transmit a new data segment, wherein said new data segment has not been previously transmitted;
multiply a retransmission timeout by a retransmission timeout multiplier;
reduce the slow start threshold to a percentage of the congestion window; and
retransmit one or more previously transmitted data segments upon a receipt of a non-duplicate acknowledgment, wherein said one or more previously transmitted data segments are not associated with one or more previously received non-duplicate acknowledgment.

24. A network node comprising:
a network interface adapted to provide connectivity to a data network;
a processor coupled to said network interface; and
a memory coupled to said processor, said memory containing processor executable instruction sequences to cause the processor to:
determine a network type of the wireless network based at least in part on one or more round trip times and one or more round trip time thresholds, wherein said one or more round trip times are associated with a plurality of data segments transmitted during said TCP session and said one or more round trip time thresholds are associated with one or more network types; and
set a plurality of TCP session parameters to a plurality of corresponding stored session parameters associated with the network type.

25. The network node of claim 24, wherein said memory further includes processor executable instruction sequences to cause the processor to determine the network type if said one or more round trip times, or a value derived from said one or more round trip times, are within a range defined at least in part by one or more of said one or more round trip time thresholds.

26. The network node of claim 25, wherein the network type is a low bandwidth network type if said one or more round trip times, or the value derived from said one or more round trip times, are greater than a low bandwidth round trip time threshold.

27. The network node of claim 25, wherein the network type is a high bandwidth network type if said one or more round trip times, or the value derived from said one or more round trip times, are less than a high bandwidth round trip time threshold.

28. The network node of claim 24, wherein one or more of said plurality of corresponding stored session parameters are adjustable.

29. The network node of claim 24, wherein said plurality of TCP session parameters include one or more of a minimum congestion window, a maximum congestion window, a maximum retransmission timeout, a congestion window increase speed, a congestion window decrease speed, and a retransmission timeout multiplier.

30. The network node of claim 29, wherein said memory further includes processor executable instruction sequences to cause the processor to limit a congestion window to a range defined by the minimum congestion window and the maximum congestion window.

31. The network node of claim 29, wherein said memory further includes processor executable instruction sequences to cause the processor to limit a slow start threshold to a range defined by the minimum congestion window and the maximum congestion window.

32. The network node of claim 29, wherein said memory further includes processor executable instruction sequences to cause the processor to increase a congestion window by the congestion window increase speed upon a receipt of a plurality of non-duplicate acknowledgments during a TCP congestion avoidance phase.

33. The network node of claim 29, wherein said memory further includes processor executable instruction sequences to cause the processor to limit a retransmission timeout for the TCP session to less than or equal to the maximum retransmission timeout.

34. The network node of claim 29, wherein said memory further includes processor executable instruction sequences to cause the processor to reduce a congestion window by the congestion window decrease speed once upon each occurrence of an event until the congestion window is less than or equal to the maximum congestion window, wherein said event is one of a receipt of one
or more non-duplicate acknowledgments or a passage of time.
